(19) United States
(12) Patent Application Publication
(10) Pub. No.: US 2009/0029745 A1
(43) Pub. Date: Jan. 29, 2009

(54) MOBILE COMMUNICATIONS TERMINALS AND METHODS USING THE SAME

(75) Inventor: William Chris Eaton, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/828,804

(22) Filed: Jul. 26, 2007

(51) Int. Cl. H04M 1/00

(52) U.S. Cl. 455/575.1

(57) ABSTRACT

A mobile communications terminal includes a portable terminal housing and a speaker in the terminal housing. The terminal housing defines a first speaker port and a second speaker port on different sides of the terminal housing. The speaker is ported through each of the first and second speaker ports. The mobile communications terminal is selectively alternatively configurable into each of a first terminal configuration, wherein the mobile communications terminal is configured for a user to listen to the speaker from the first speaker port, and a second terminal configuration, wherein the mobile communications terminal is configured for a user to listen to the speaker from the second speaker port.

### FIELD OF THE INVENTION

The present invention relates to electronic devices and, more particularly, to mobile communications terminals and methods using the same.

### BACKGROUND OF THE INVENTION

Manufacturers and designers of personal mobile communications terminals such as cellular telephones often desire to reduce the overall dimensions of such devices and also provide flexibility of use. One well-known type of mobile communications terminal is a clamshell or flip phone including two housing parts pivotally joined by a hinge. It is also known to provide an additional swivel mechanism to permit a user to pivot one of the housing parts relative to the other housing part about an axis that is generally perpendicular to the hinge so that the swivelable housing part can be reversed.

### SUMMARY OF THE INVENTION

According to embodiments of the present invention, a mobile communications terminal includes a portable terminal housing and a speaker in the terminal housing. The terminal housing defines a first speaker port and a second speaker port on different sides of the terminal housing. The speaker is ported through each of the first and second speaker ports. The mobile communications terminal is selectively alternatively configurable into each of a first terminal configuration, wherein the mobile communications terminal is configured for a user to listen to the speaker from the first speaker port, and a second terminal configuration, wherein the mobile communications terminal is configured for a user to listen to the speaker from the second speaker port.

According to some embodiments, the mobile communications terminal is configured to process an input audio signal using a first set of parameters when the mobile communications terminal is in the first terminal configuration and to process an input audio signal using a second set of parameters when the mobile communications terminal is in the second terminal configuration, the second set of parameters being different from the first set of parameters. According to some embodiments, the first set of parameters and the second set of parameters each include electronic frequency response correction to compensate for differences in mechanical acoustic characteristics associated with each of the first and second terminal configurations.

According to embodiments of the present invention, a method includes providing a mobile communications terminal including: a portable terminal housing defining a first speaker port and a second speaker port on different sides of the terminal housing; and a speaker in the terminal housing, wherein the speaker is ported through each of the first and second speaker ports; wherein the mobile communications terminal is selectively alternatively configurable into each of a first terminal configuration, wherein the mobile communications terminal is configured for a user to listen to the speaker from the first speaker port, and a second terminal configuration, wherein the mobile communications terminal is configured for a user to listen to the speaker from the second speaker port. The method further includes: listening to the speaker from the first speaker port with the mobile communications terminal in the first terminal configuration; and thereafter listening to the speaker from the second speaker port with the mobile communications terminal in the second terminal configuration.

According to some embodiments, the method includes: processing an input audio signal using a first set of parameters when the mobile communications terminal is in the first terminal configuration; and processing an input audio signal using a second set of parameters when the mobile communications terminal is in the second terminal configuration, wherein the second set of parameters is different from the first set of parameters. According to some embodiments, the first set of parameters and the second set of parameters each include electronic frequency response correction to compensate for differences in mechanical acoustic characteristics associated with each of the first and second terminal configurations.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a schematic diagram of a mobile wireless communications terminal according to embodiments of the present invention and an exemplary wireless communications network.

FIG. 2 is a perspective view of the mobile wireless communications terminal of FIG. 1 in a first terminal configuration.

FIG. 3 is a perspective view of the mobile wireless communications terminal of FIG. 1 in a second terminal configuration.

FIG. 4 is a perspective view of the mobile wireless communications terminal of FIG. 1 in a third terminal configuration.

FIG. 5 is a perspective view of the mobile wireless communications terminal of FIG. 1 in a fourth terminal configuration.

FIG. 6 is an enlarged, fragmentary, side view of the mobile communications terminal of FIG. 1.

### DETAILED DESCRIPTION OF EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof. As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

As used herein, “electronic component” means an active device as contrasted with a passive electrical connector or the like. An electronic component may include a processor.

As used herein, a “communication terminal” includes, but is not limited to, a terminal that is configured to receive/transmit communication signals via a wireline connection, such as via a public-switched telephone network (PSTN), digital subscriber line (DSL), digital cable, or another data connection/network, and/or via a wireless interface with, for example, a cellular network, a satellite network, a wireless local area network (WLAN), and/or another communication terminal.

When the communication terminal is configured to communicate over a wireless interface, it is referred to herein as a “wireless communication terminal” or a “wireless terminal.” Examples of wireless terminals include, but are not limited to, a cellular telephone, personal data assistant (PDA), pager, and/or a computer that is configured to communicate data over a wireless communication interface that can include a cellular telephone interface, a Bluetooth interface, a wireless local area network interface (e.g., 802.11), another RF communication interface, and/or an optical/infra-red communication interface.

As used herein, “mobile terminals” may be portable, transportable, installed in a vehicle (aeronautical, maritime, or land-based), or situated and/or configured to operate locally and/or in a distributed fashion at any other location(s) on earth and/or in space.

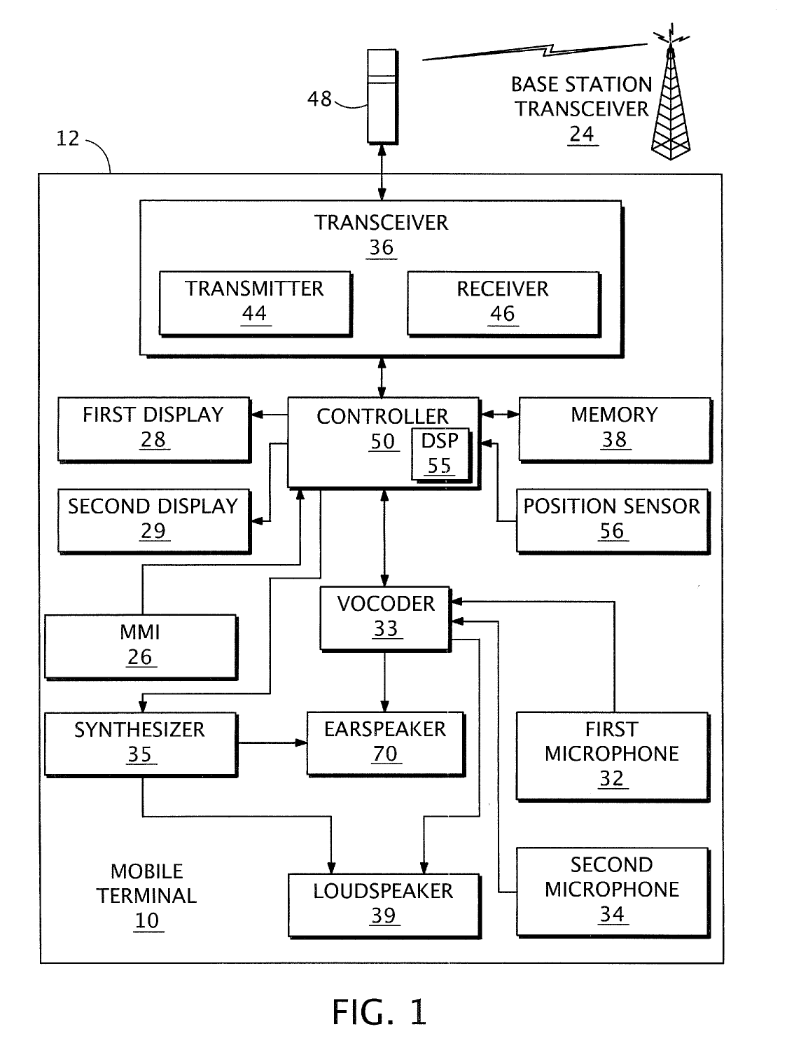

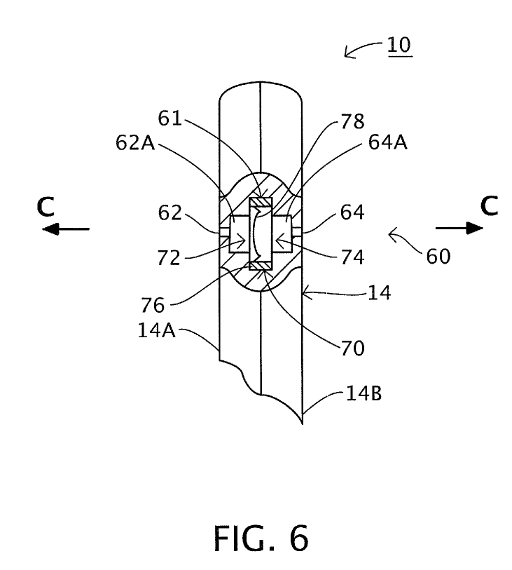

Embodiments of the present invention will now be described below with respect to FIGS. 1-6. Embodiments of the present invention provide a mobile wireless communications terminal 10 including a speaker assembly 60 (FIG. 6) that may be used with the mobile terminal 10 in multiple operational configurations. The mobile wireless communications terminal may provide improvements and advantages in performance and/or usability over conventional speaker arrangements of mobile wireless communications terminals.

Referring now to FIG. 1, an exemplary radiotelephone communication system in accordance with embodiments of the present invention is illustrated, which includes the mobile wireless communication terminal 10 and a base station transceiver, which is part of a wireless communications network 24. In some embodiments of the present invention, the network 24 includes a base station transceiver that includes the radio transceiver(s) that define an individual cell in a cellular network and communicates with the mobile terminal 10 and other mobile terminals in the cell using a radio-link protocol. It will be understood that, in some embodiments of the present invention, many base station transceivers may be connected through, for example, a mobile switching center and other devices to define a wireless communications network.

The mobile terminal 10 includes a portable housing 12, a man machine interface (MMI) 26, a first display device 28, a second display device 29, a first microphone 32, a voice coder/decoder (“voice codec” or “vocoder”) 33, a second microphone 34, a synthesizer 35, a transceiver or communication module 36, a memory 38 including application information and parameters, a loudspeaker 39, a processor or controller 50, a position switch or sensor 56, and a speaker 70. The controller 50 supports various functions of the terminal 10, including decoding received voice and other audio signals from the microphones 32, 34 and providing decoded voice and other audio signals to the loudspeaker 39 and the speaker 70.

The communication module 36 can include a cellular communication module, a direct point-to-point connection module, and/or a WLAN module. With a cellular communication module, the wireless terminal 10 can communicate via the base station(s) of the network using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations may be connected to a Mobile Telephone Switching Office (MTSO) wireless network, which, in turn, can be connected to a PSTN and/or another network.

The communication module 36 may include a transceiver typically having a transmitter circuit 44 and a receiver circuit 46, which respectively transmit outgoing radio frequency signals (e.g., to the network 24, a router or directly to another terminal) and receive incoming radio frequency signals (e.g., from the network 24, a router or directly from another terminal), such as voice and data signals, via an antenna 48. The communication module 36 may include a short-range transmitter and receiver, such as a Bluetooth transmitter and receiver. The antenna 48 may be an embedded antenna, a retractable antenna or any antenna known to those having skill in the art without departing from the scope of the present invention. The radio frequency signals transmitted between the mobile terminal 10 and the network 24 may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver may include an infrared (IR) transceiver configured to transmit/receive infrared signals to/from other electronic devices via an IR port.

The controller 50 may support various functions of the mobile terminal 10. The controller 50 can be any commercially available or custom microprocessor, for example. The controller 50 includes or is operably connected with a digital signal processor (DSP) 55, as discussed below. The controller 50 is connected with the memory 38, which may include applications or modules configured to execute the operations and steps described herein via the controller 50, for example. The components and functions of the controller 50 may be distributed.

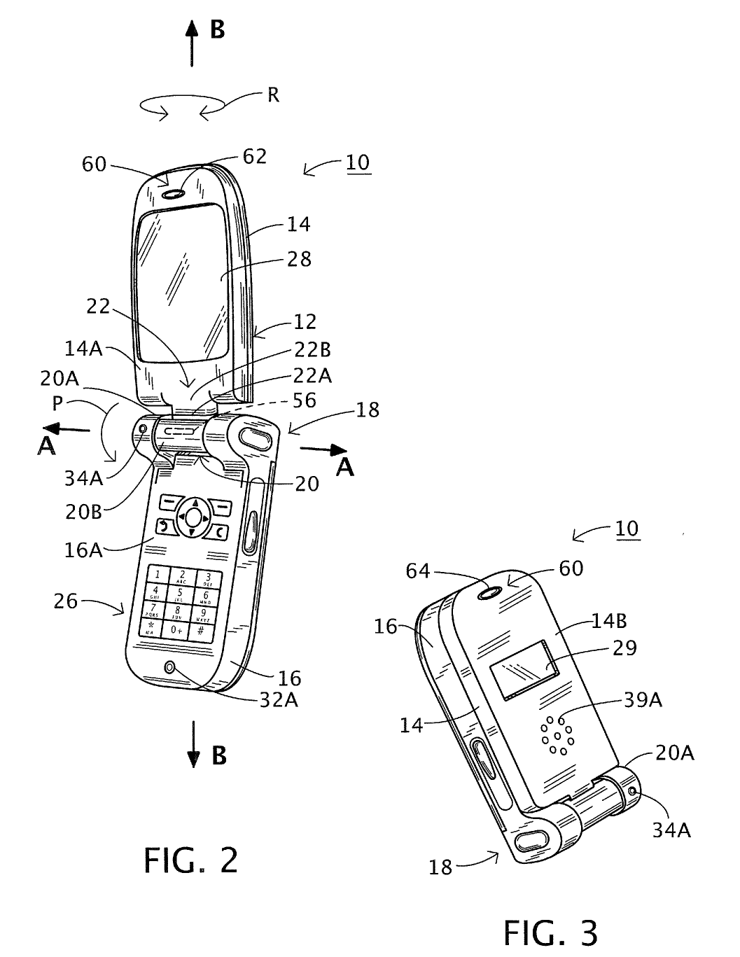

Referring to FIG. 2, the MMI 26 includes a set of mechanical input devices mounted on the front side 16A of the lower housing portion 16. As illustrated, the MMI 26 includes a keypad.

The first display device 28 and the second display device 29 may each include, for example, a liquid crystal display (LCD) module. In use, the controller 30 of the mobile terminal 10 generates display images on the display devices 28, 29. The display devices 28, 29 may each be used to display different types of information and/or to display information in different modes of operation or terminal configurations.

The vocoder 33 and the synthesizer 35 are connected to the controller 50. The vocoder 33 may support various voice (speech) processing operations related to converting digital communication signals to a form suitable for output by the speakers 39, 70 or converting analog voice signals from the microphones 32, 34 to digital communication signals. Examples of suitable vocoders for use with embodiments of the present invention are well known to those of skill in the art and will not be further described herein. The synthesizer 35 may be a musical instrument digital interface (MIDI) synthesizer, for example.

The first microphone 32 and the second microphone 34 are each coupled to an audio processor, such as the vocoder 33, that is configured to generate an audio data stream responsive to sound incident on the microphone. The microphones 32, 34 are positioned at different operational locations on the terminal as described below.

The speaker 70 generates sound responsive to an input audio signal, such as from the controller 50 via the vocoder 33 or the synthesizer 35. The speaker 70 may be an acoustic transducer of any suitable type and construction. According to some embodiments, the speaker 70 is a loudspeaker and, according to some embodiments, a diaphragm loudspeaker. According to some embodiments, the speaker 70 is a micro-speaker and, according to some embodiments, a diaphragm micro-speaker. According to some embodiments and with reference to FIG. 6, the speaker 70 has a front face 72 and a rear face 74 and includes a speaker housing 76 on which a diaphragm 78 is mounted. Voice coils (not shown) may be connected to the diagram 78 and excited by a magnetic package (not shown) to drive the diaphragm 78. Micro-speakers of this type are well-known and therefore will not be described herein in further detail. Other types of speakers, such as a piezo ceramic speaker, may be employed. According to some embodiments, the speaker 70 is adapted to serve as an earspeaker for on-ear listening (i.e., the user's ear is on or proximate the mobile terminal 10).

The loudspeaker 39 also generates sound responsive to an input audio signal, such as from the controller 50 via the vocoder 33 or the synthesizer 35. The loudspeaker 39 may be an acoustic transducer of any suitable type and construction. According to some embodiments, the loudspeaker 39 is adapted to serve as a loudspeaker for speakerphone or off-ear listening (i.e., the user's ear is spaced apart from the terminal 10 a distance of at least about 10 cm and, according to some embodiments, at least 20 cm).

The position switch or sensor 56 is connected to the controller 50. The position sensor 56 is operative to provide the controller 50 with a signal indicative of the position or configuration of the housing 12 of the terminal 10, as discussed below.

At least some of the foregoing components of the mobile terminal 10 may be included in many conventional mobile terminals and their functionality is generally known to those skilled in the art. As used herein, the term “portable electronic device” or “mobile terminal” may include: a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; a gaming device, an audio video player, and a conventional laptop and/or palmtop portable computer that may include a radiotelephone transceiver.

According to some embodiments and as illustrated in FIGS. 2-5, the mobile terminal 10 is a handheld (portable) mobile terminal. By “handheld mobile terminal,” it is meant that the outer dimensions of the mobile terminal are adapted and suitable for use by a typical operator using one hand. According to some embodiments, the total volume of the handheld mobile terminal is less than about 200 cc. According to some embodiments, the total volume of the handheld terminal is less than about 100 cc. According to some embodiments, the total volume of the handheld mobile terminal is between about 50 and 100 cc. According to some embodiments, no dimension of the handheld mobile terminal 10 exceeds about 200 mm.

The housing 12 may be formed of a polymeric material, such as polystyrene. Alternatively or additionally, the housing 12 may be formed of any other suitable material, such as metal. The housing 12 may be molded and may be assembled from multiple parts. The housing 12 includes an upper or top subhousing or housing portion 14 and a lower or bottom subhousing or housing portion 16.

The housing portions 14, 16 have respective front walls 14A, 16A defining their front sides and respective rear walls 14B, 16B defining their rear sides. One or both of the housing portions 14, 16 define an interior cavity (not shown) that contains various components of the mobile terminal 10, including the controller 50.

The upper housing portion 14 is pivotally coupled to the lower housing portion 16 by a hinge mechanism 18. The hinge mechanism 18 includes a pivot mechanism 20 and a swivel mechanism 22. The pivot mechanism 20 includes a pivot arm 20B rotatably mounted in pivot posts 20A. The swivel mechanism 22 includes a swivel arm 22B rotatably mounted in a swivel socket 22A.

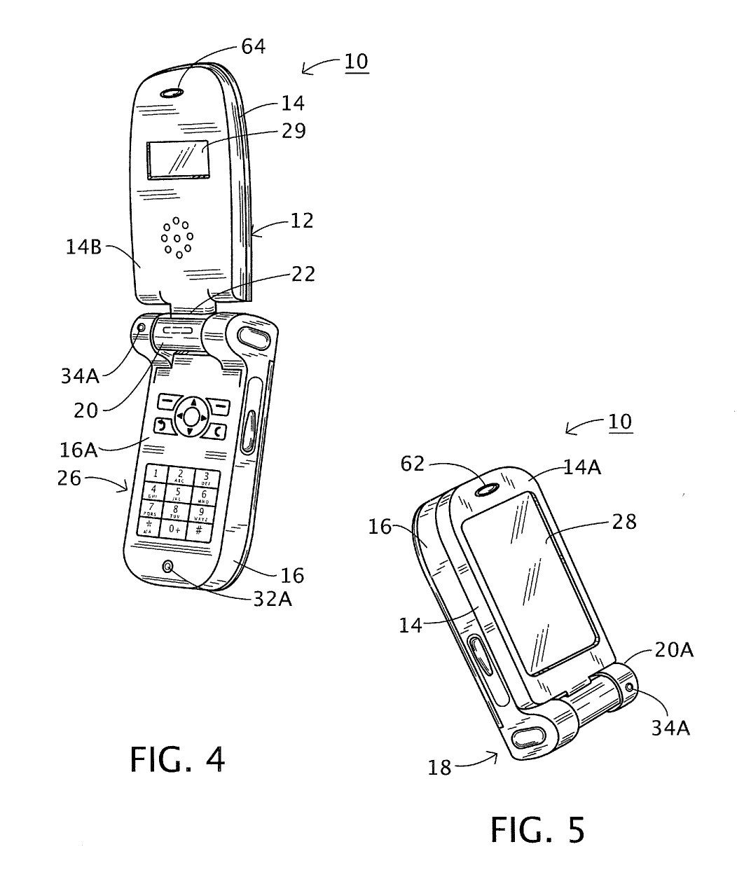

The housing portions 14, 16 can be pivoted in directions P about a first axis A-A of the pivot mechanism 20 between open positions wherein the housing portion 14 is extends away from the housing portion 16 as shown in FIGS. 2 and 4 and closed positions wherein the housing portion 14 overlies the housing portion 16 as shown in FIGS. 3 and 5. The housing portions 14, 16 can also be pivoted in directions R about a first axis B-B (which is transverse to the axis A-A) of the swivel mechanism 22 between forward positions as shown in FIGS. 2 and 3 and reversed positions as shown in FIGS. 4 and 5. Using the mechanisms 20, 22, the housing 12 can be selectively configured in each of the following configurations: a first terminal configuration as shown in FIG. 2, a second terminal configuration as shown in FIG. 3, a third terminal configuration as shown in FIG. 4, and a fourth terminal configuration as shown in FIG. 5. According to some embodiments, the axis A-A is perpendicular to the axis B-B. Handheld wireless communication terminals having clamshell housings with hinge mechanisms that pivot about transverse or perpendicular axes as shown may be referred to as “swivel flip phones.”

The first display 28 is mounted in the front wall 14A of the upper housing portion 14. The second display 29 is mounted in the rear wall 14B of the upper housing portion 14.

A first microphone port 32A is defined in the front wall 16A and a second microphone port 34A is defined in the front face of the pivot post 20A. The first microphone 32 is mounted to receive acoustic signals through the port 32A. The second microphone 34 is mounted to receive acoustic signals through the port 34A.

Loudspeaker ports 39A (FIG. 3) are provided in the rear wall 14B. The loudspeaker 39 is mounted in the housing part 14 to direct sound through the loudspeaker ports 39A.

With reference to FIG. 6, the housing portion 14 includes a speaker cavity 61, opposed front and rear speaker passages 62A, 62B, and opposed front and rear speaker ports 62, 64. The speaker 70 is mounted in the speaker cavity 61. The speaker 70 is mounted in the cavity 61 such that the speaker front face 72 faces the front port 62 and the speaker rear face 74 faces the rear port 64. According to some embodiments, the front and rear speaker ports 62, 64 are diametrically opposed and positioned on a common axis C-C extending front-to-rear and through the speaker membrane 78. This arrangement may allow for a particularly thin side profile for the housing portion 14. The speaker 70 and the housing features 61, 62A, 62B, 62, 64 together form the speaker assembly 60. According to some embodiments, the speaker assembly 60 is an acoustically tuned speaker assembly.

As discussed above, the terminal 10 is selectively configurable in each of the first, second, third and fourth alternative terminal configurations. The terminal 10 may thereby provide enhanced flexibility and convenience to the user. For example, the user may select the operational form factor of the terminal 10. The user may also select which display 28, 29 is facing the user, providing enhanced flexibility in using the displays 28, 29. In each of the first, second, third and fourth terminal configurations, the terminal 10 enables the user to listen to the speaker 70 through at least one of the front speaker port 62 and the rear speaker port 64. Thus, the speaker 70 serves as the output speaker in multiple terminal configurations. Accordingly, the volume and shape requirements for providing speaker performance in the multiple terminal configurations may be reduced. Moreover, the speaker 70 serves as a reversible speaker. According to some embodiments, the speaker 70 is used as a reversible earspeaker. According to some embodiments, selective frequency response correction is applied to the speaker 70 depending on the terminal configuration.

The terminal 10 may compensate or correct for different mechanical acoustic characteristics of the terminal 10 attendant to each of the terminal configurations. For example, the acoustics of the speaker assembly 60 as received by the user will be affected by which speaker port 62, 64 is facing the user, whether the opposite port 62, 64 is open (e.g., as in the configurations of FIGS. 2 and 4) or is blocked (e.g., by the housing portion 16 as in the configurations of FIGS. 3 and 5), and/or other mechanical variations in the terminal 10.

The controller 50 can electronically compensate, in whole or in part, for acoustic variations such as those described above. The controller 50 provides an audio drive signal to the speaker 70. The controller 50 determines the configuration of the terminal 10 from the position sensor 56. The controller 50 enables a speaker mode corresponding to the determined terminal configuration. According to some embodiments, the controller 50 automatically (i.e., without further user input required) selects and enables the speaker mode based on the indication from the position sensor 56. A first speaker mode is enabled when the terminal 10 is in the first terminal configuration, a second speaker mode is enabled when the terminal 10 is in the second terminal configuration, a third speaker mode is enabled when the terminal 10 is in the third terminal configuration, and a fourth speaker mode is enabled when the terminal 10 is in the fourth terminal configuration. The audio drive signal supplied to the speaker 70 is controlled or processed in accordance with the current speaker mode (and, therefore, the current terminal configuration). More particularly, the audio drive signal provided to the speaker 70 is processed using a first set of parameters when the terminal 10 is in the first terminal configuration (FIG. 2), a second set of parameters when the terminal 10 is in the second terminal configuration (FIG. 3), a third set of parameters when the terminal 10 is in the third terminal configuration (FIG. 4), and a fourth set of parameters when the terminal 10 is in the fourth terminal configuration (FIG. 5). Some or all of the first, second, third and fourth parameter sets differ from one another to adjust for differences in the mechanical acoustics of the speaker assembly 60 in the respective terminal configurations.

According to some embodiments, the first, second, third and fourth parameter sets are each adapted to correct for variations in the frequency response of the speaker assembly 60 attributable to the mechanical acoustics of the selected terminal configuration. According to some embodiments, the first, second, third and fourth parameter sets are each adapted to correct for the frequency response of the speaker assembly 60 to provide a system frequency response that matches or approximates a prescribed target frequency response. As used herein, “system frequency response” refers to the frequency response of the speaker assembly 60 and the electronic frequency response correction in combination. That is “system frequency response” means the frequency from the speaker assembly 60 responsive to an input audio signal (e.g., from the receiver 46 or the memory 38) when the speaker assembly 60 is driven by the audio drive signal from the controller 50 and the audio drive signal embodies the input audio signal and any electronic compensation thereto provided by the controller 50. In this manner, the terminal 10 can provide the same or approximately the same frequency response to the user regardless of the terminal configuration being employed. According to some embodiments, the target frequency response is the same for each of the first, second, third and fourth speaker modes.

According to some embodiments, the target frequency response complies with or to a mask for receiving frequency response as specified in the 3GPP TS 126 132 7.4.2 specification.

The first, second, third and fourth audio signal processing parameter sets may include different equalization parameters for each respective terminal configuration/speaker mode. The different equalization parameter sets may serve to boost and/or attenuate selected frequencies. The different equalization parameter sets may compensate for variations in the frequency response of the speaker assembly 60 in different terminal configurations. According to some embodiments, the equalization parameters are selected to provide substantially the same frequency response from the front port 62 when the terminal 10 is in the first terminal configuration, from the rear port 64 when the terminal 10 is in the second terminal configuration, from the rear port 64 when the terminal 10 is in the third terminal configuration, and from the front port 62 when the terminal 10 is in the fourth terminal configuration.

The first, second, third and fourth audio signal processing parameter sets may include different sensitivity parameters for each terminal configuration/speaker mode. The different sensitivity parameter sets may compensate for variations in the efficiency of the speaker assembly 60 in different terminal configurations. According to some embodiments, the sensitivity parameters are selected to provide substantially the same sensitivity from the front port 62 when the terminal 10 is in the first terminal configuration, from the rear port 64 when the terminal 10 is in the second terminal configuration, from the rear port 64 when the terminal 10 is in the third terminal configuration, and from the front port 62 when the terminal 10 is in the fourth terminal configuration.

The controller 50 may process the input audio signal as described herein using any suitable apparatus and technique. According to some embodiments, the DSP 55 executes the audio signal processing to apply the first, second, third and fourth parameter sets in the first, second, third and fourth speaker modes. The DSP 55 is configured to receive an input audio signal, for example, from the receiver 46 and/or the memory 38, and to process the received input audio signal using the processing parameters set corresponding to the selected terminal configuration/speaker mode. The first, second, third and fourth parameter sets may include respective first, second, third or fourth digital filter coefficients suitable to equalize or otherwise modify the input audio signal as described herein.

According to some embodiments, each of the first, second, third and fourth terminal configurations/speaker modes is adapted for use of the terminal 10 by the user in a handheld conversation mode (i.e., with the terminal 10 held adjacent the user's head such the speaker port in use is positioned adjacent the user's ear and the microphone in use is generally proximate the user's mouth).

According to some embodiments, the controller 50 modifies the input audio signal to provide an audio drive signal to the speaker 70 such that the output from the speaker assembly 60 is suitable for acoustic coupling of the speaker 70 to a human ear (i.e., earspeaker acoustic coupling) at the front speaker port 62, when the terminal 10 is in the first or fourth terminal configuration, and at the rear speaker port 64, when the terminal 10 is in the second or third terminal configuration.

The controller 50 may also place the terminal 10 in a loudspeaker mode (i.e., a fifth speaker mode) responsive to selection of a loudspeaker or speakerphone mode by the user. In the loudspeaker mode, the controller 50 provides an audio drive signal to the loudspeaker 39 instead of the speaker 70.

The controller 50 may also control the operation of the microphones 32, 34 in accordance with the terminal configuration. When the housing 12 is in the first or third terminal configuration (FIGS. 2 and 4), the controller 50 enables the microphone 32 and disables the microphone 34. When the housing 12 is in the second or fourth terminal configuration (FIGS. 3 and 5), the controller 50 enables the microphone 34 and disables the microphone 32.

While four terminal configurations are shown and described herein, terminals according to further embodiments may be configurable and usable in more or fewer terminal configurations/speaker modes. For example, the terminal 10 may be enabled to drive the speaker 70 only in the first and third terminal configurations/speaker modes.

While a position sensor 56 has been described above for indicating the terminal configuration to the controller 50, other types of switches or sensors may be used. For example, a Hall effect sensor or the like may be employed in place of or in addition to the position sensor 56.

While the speaker ports 62, 64 are shown and described as located on opposed front and rear faces of the housing portion 14, in accordance with other embodiments, one or both of the speaker ports may be located elsewhere on the housing 12.

While display devices 28, 29 are shown on either side 14A, 14B of the housing portion 14, according to further embodiments, a display device is only provided on one side.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed is:

1. A mobile communications terminal comprising:
a portable terminal housing defining a first speaker port and a second speaker port on different sides of the terminal housing; and
a speaker in the terminal housing, wherein the speaker is ported through each of the first and second speaker ports;
wherein the mobile communications terminal is selectively alternatively configurable into each of a first terminal configuration, wherein the mobile communications terminal is configured for a user to listen to the speaker from the first speaker port, and a second terminal configuration, wherein the mobile communications terminal is configured for a user to listen to the speaker from the second speaker port.

2. The mobile communications terminal of claim 1 configured to process an input audio signal using a first set of parameters when the mobile communications terminal is in the first terminal configuration and to process an input audio signal using a second set of parameters when the mobile communications terminal is in the second terminal configuration, wherein the second set of parameters is different from the first set of parameters.

3. The mobile communications terminal of claim 2 wherein the first set of parameters and the second set of parameters each include electronic frequency response correction to compensate for differences in mechanical acoustic characteristics associated with each of the first and second terminal configurations.

4. The mobile communications terminal of claim 1 including a position sensor to determine whether the mobile communications terminal is in the first terminal configuration or the second terminal configuration.

5. The mobile communications terminal of claim 1 wherein the terminal housing has first and second opposed sides and the first and second speaker ports are defined in the first and second housing sides, respectively.

6. The mobile communications terminal of claim 1 wherein the terminal housing includes first and second housing parts pivotally connected to one another and the first and second speaker ports are defined in the first housing part.

7. The mobile communications terminal of claim 6 wherein the first and second housing parts are relatively pivotable about at least two transverse axes.

8. The mobile communications terminal of claim 7 wherein:
the mobile communications terminal is further selectively alternatively configurable into each of a third terminal configuration, wherein the mobile communications terminal is configured for the user to listen to the speaker from the first speaker port, and a fourth terminal configuration, wherein the mobile communications terminal is configured for a user to listen to the speaker from the second speaker port;
in the first terminal configuration, the first housing part is pivoted away from the second part and the first speaker port is forward facing;
in the second terminal configuration, the first housing part is folded onto the second part and the second speaker port is forward facing;
in the third terminal configuration, the first housing part is pivoted away from the second part and the second speaker port is forward facing; and
in the fourth terminal configuration, the first housing part is folded onto the second part and the first speaker port is forward facing.

9. The mobile communications terminal of claim 1 wherein:
when the mobile communications terminal is in the first terminal configuration, the mobile communications terminal is configured for the user to use the first speaker port as an earspeaker port; and
when the mobile communications terminal is in the second terminal configuration, the mobile communications terminal is configured for the user to use the second speaker port as an earspeaker port.

10. The mobile communications terminal of claim 1 wherein the mobile communications terminal is a cellular telephone.

11. The mobile communications terminal of claim 1 wherein the mobile communications terminal is a handheld wireless communications terminal.

12. A method comprising:
providing a mobile communications terminal including:
a portable terminal housing defining a first speaker port and a second speaker port on different sides of the terminal housing; and
a speaker in the terminal housing, wherein the speaker is ported through each of the first and second speaker ports;
wherein the mobile communications terminal is selectively alternatively configurable into each of a first terminal configuration, wherein the mobile communications terminal is configured for a user to listen to the speaker from the first speaker port, and a second terminal configuration, wherein the mobile communications terminal is configured for a user to listen to the speaker from the second speaker port;
listening to the speaker from the first speaker port with the mobile communications terminal in the first terminal configuration; and thereafter
listening to the speaker from the second speaker port with the mobile communications terminal in the second terminal configuration.

13. The method of claim 12 including:
processing an input audio signal using a first set of parameters when the mobile communications terminal is in the first terminal configuration; and
processing an input audio signal using a second set of parameters when the mobile communications terminal is in the second terminal configuration, wherein the second set of parameters is different from the first set of parameters.

14. The method of claim 13 wherein the first set of parameters and the second set of parameters each include electronic frequency response correction to compensate for differences in mechanical acoustic characteristics associated with each of the first and terminal configurations.

15. The method of claim 12 including determining whether the mobile communications terminal is in the first terminal configuration or the second terminal configuration using a position sensor forming a part of the mobile communications terminal.

16. The method of claim 12 wherein the terminal housing has first and second opposed sides and the first and second speaker ports are defined in the first and second housing sides, respectively.

17. The method of claim 12 wherein the terminal housing includes first and second housing parts pivotally connected to one another and the first and second speaker ports are defined in the first housing part.

18. The method of claim 17 wherein the first and second housing parts are relatively pivotable about at least two transverse axes.

19. The method of claim 18 wherein:
the mobile communications terminal is further selectively alternatively configurable into each of a third terminal configuration, wherein the mobile communications terminal is configured for the user to listen to the speaker from the first speaker port, and a fourth terminal configuration, wherein the mobile communications terminal is configured for a user to listen to the speaker from the second speaker port;
in the first terminal configuration, the first housing part is pivoted away from the second part and the first speaker port is forward facing;
in the second terminal configuration, the first housing part is folded onto the second part and the second speaker port is forward facing;
in the third terminal configuration, the first housing part is pivoted away from the second part and the second speaker port is forward facing; and
in the fourth terminal configuration, the first housing part is folded onto the second part and the first speaker port is forward facing; and
the method further includes:
listening to the speaker from the first speaker port with the mobile communications terminal in the third terminal configuration; and thereafter
listening to the speaker from the second speaker port with the mobile communications terminal in the fourth terminal configuration.

20. The method of claim 12 wherein:
using the first speaker port as an earspeaker port with the mobile communications terminal in the first terminal configuration; and
use the second speaker port as an earspeaker port with the mobile communications terminal in the second terminal configuration.

21. The method of claim 12 wherein the mobile communications terminal is a cellular telephone.

22. The method of claim 12 wherein the mobile communications terminal is a handheld wireless communications terminal.
